(19) United States
(12) Patent Application Publication
(10) Pub. No.: US 2017/0039467 A1
(43) Pub. Date: Feb. 9, 2017

(54) Neuron network signal detection device

(71) Applicants: Jun MA, GANSU PROVINCE (CN); Chunni WANG, GANSU PROVINCE (CN); Guodong REN, GANSU PROVINCE (CN)

(72) Inventors: Jun MA, GANSU PROVINCE (CN); Chunni WANG, GANSU PROVINCE (CN); Guodong REN, GANSU PROVINCE (CN)

(21) Appl. No.: 14/818,313

(22) Filed: Aug. 5, 2015

(51) Int. Cl. G06N 3/063; G06N 3/04

(52) U.S. Cl. CPC G06N 3/0635; G06N 3/04

(57) ABSTRACT

A neuron network signal detection device is disclosed herein, comprising at least two coupled neurons, each neuron is connected to a sensor that transmits DC signal and the output terminal of coupled neuron is connected to a synchronization judgment unit. When adopting the above scheme, the physical or biological signals are converted to DC signals, which act on the mutually coupled neuron or neuron-like circuit. When the coupling strength reaches a certain value, the discharge behaviors of neuron or neuron-like circuit network will also achieve synchronization, and the synchronization judgment unit can detect the output voltage or current response of this kind of circuit.

### BACKGROUND OF THE INVENTION

The present invention relates to neuron fields, in particular, to the neuron signal detection technique.

Neurons are widespread in living bodies. They are the basic units of information processing and able to make appropriate response under different external stimuli. Since the excitation transmission between neurons is unidirectional, which makes the excitation conduction in a complete reflex arc in unidirectional, the excitation is transmitted in from afferent nerves and transmitted out from the efferent nerves. Neurons may produce response to the transmembrane ion currents that flow in and out, exhibiting the discharge behaviors of neuronal membrane potential, such as resting, spiking discharge, bursting discharge or chaotic discharge, etc. When the neuronal transmembrane ion current is low, the neuronal membrane potential motor performance is resting; under the action of higher neuronal transmembrane ion current, the neuronal membrane potential motor performance is spiking discharge, bursting discharge or chaotic discharge.

In early 1980s, Dr. John J. Hopfield, a biophysicist in California Institute of Technology published an important paper. In the paper, dynamical model was used in fully connected neural network and integrated circuit hardware is used to implement this dynamic system. His work provided reliable basis for solving actual problems with neural networks in other fields. However, the basic unit of this type of neural network is not neuron, which can be an electronic component or electronic circuit; thus, it is known as artificial neural networks. Dr. Hopfield's work and research brought a new climax in the research in artificial neural networks. The artificial neural network system is to simulate the structure and functions of artificial neural cells using a physically realizable system.

In early 1990s, Eckhorn proposed a neural network model. These biological models are the basis of models coupling the neural network connection modes. In the model, neuronal synchronization occurs through mutual coupling excitation. Neurons can realize synchronized bursting of similar input data. The slight improvement in the above biological neural network model can constitute different topologies such as “small world”, “scale-free” or “regular connection” neural network. Neuron coupling system is an emerging study area of nonlinear dynamics. The coupled oscillation and synchronization is a basic phenomenon of nonlinear dynamics, which occurs in many physical, communication, ecology and nervous systems, and the collective oscillation behaviors play an important role. In particular, in recent years, synchronization and desynchronization of coupling neuron system is the key for studying brain information processing. At abroad, Bazhenovt et al studied the chaotic behavior of chain inhibitory chemical synapse coupling. In china, Shi Xia et al studied the electrically coupled synchronous mode with the ring structure. Wang Qingyun et al studied the sufficient condition for synchronization of coupling neuron network with symmetric structure in the paper “Sync dynamics of neuron coupling system”. Du Yanhai et al studied the synchronous oscillation of FitzHugh Nagumo coupled by N nearest coupling networks, etc. The inventor also studied the influence of noise on synchronous generation of coupling neurons in paper “Detection of noise effect on coupled neuronal circuits” published in Commun Nonlinear Sci Numer Simulat.

In the medical field, patients with neurological or psychiatric diseases (such as Parkinson's disease, essential tremor, dystonia or obsessive-compulsive disorder) have morbidly active nerve cell population in the localized brain regions (such as the thalamus and basal ganglia), which will aggravate the disease due to synchronization, therefore, it is necessary to study mechanism of neuronal synchronization and inhibit the occurrence of synchronization.

Traditional weak signal detection circuit adopts the sensor and amplifier structure, and the amplifier should be sensitive, of high-precision, that is, sufficient gain, low input offset and excellent linearity; for example, the read amplifier of hard disk data. Usually, the noise will reduce the SNR of signals, affecting the extraction of useful information. In some nonlinear systems, the noise can enhance the detection ability of weak signals, which is called stochastic resonance phenomenon. Bing Liang et al. published a paper “transmission characteristics of weak signals in Hodgkin-Huxley neuronal unidirectional coupling system” in the Chinese Journal of Physics (ISSUE 7, 2009). It adopted the stochastic resonance weak signal detection system, as shown in FIG. 1, that is, by modulating the external noise intensity to appropriate value and stochastic resonance state, to maximize the SNR of signal output and achieve the purpose of weak signal detection. This scheme needs to induce stochastic resonance by the noise, and judge whether there is signal output through detecting the SNR. As the stochastic resonance is not controllable and the judgment of SNR may have error, it has many shortcomings.

### BRIEF SUMMARY OF THE INVENTION

The purpose of the present invention is to provide a neuron network signal detection device.

To achieve the above purpose, the neuron network signal detection device herein comprises at least two coupled neurons, each neuron is connected to a sensor that transmits DC signal and the output terminal of coupled neuron is connected to a synchronization judgment unit.

The said neuron also connects a noise generator.

The said neuron is bidirectionally coupled.

When adopting the above scheme, the physical or biological signals are converted to DC signals, which act on the mutually coupled neuron or neuron-like circuit. When the coupling strength reaches a certain value, the discharge behaviors of neuron or neuron-like circuit network will also achieve synchronization, and the synchronization judgment unit can detect the output voltage or current response of this kind of circuit.

### BRIEF DESCRIPTION OF THE DRAWINGS

FIG. 1 is the schematic diagram of conventional signal detection device;

FIG. 2 is the schematic diagram of neuron coupling structure in the present invention;

FIG. 3 is the current curve of neuron coupling test results;

FIG. 4 is the circuit diagram of neural networks in the present invention;

FIG. 5 is the schematic diagram of the present invention.

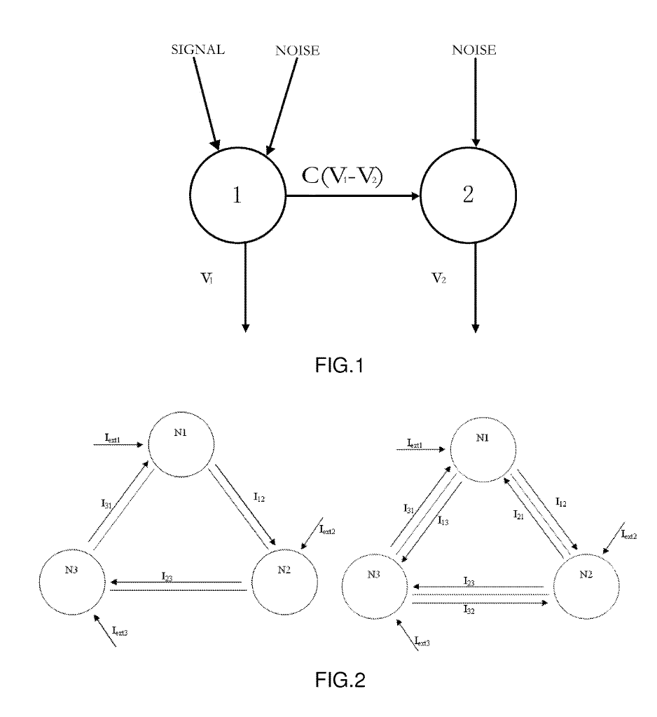

### DETAILED DESCRIPTION OF THE INVENTION

To specify the technical content, structural characteristics, purpose and effect of the device, the invention is described herein in connection with drawings and certain specific embodiments.

Neuronal network is constituted by neurons through mutual coupling. When the coupling strength between neurons is low and transmembrane ion current is week, the discharge behavior of neuron network is asynchronous. When the transmembrane ion current of neuron reaches a certain threshold, the discharge behavior of neuron network will be synchronous; or when the coupling strength between neuron reaches a certain threshold, the discharge behavior of neuronal network will also be synchronous.

FIG. 2 shows the neuronal coupling structure, of which, the left figure shows the unidirectional coupling neurons, and the right one shows the bidirectional coupling neurons,

\dot{x}₁=y₁−ax₁³+bx₁²−z₁+I_{ext,1}+D(x₃−x₁)+ξ(t)

\dot{x}₂=y₂−ax₂³+bx₂²−z₂+I_{ext,2}+D(x₁−x₂)+ξ(t)

\dot{x}₃=y₃−ax₃³+bx₃²−z₃+I_{ext,3}+D(x₂−x₃)+ξ(t)

\dot{x}₁=y₁−ax₁³+bx₁²−z₁+I_{ext,1}+D(x₃+x₂−2x₁)+ξ(t)

\dot{x}₂=y₂−ax₂³+bx₂²−z₂+I_{ext,2}+D(x₁+x₁−2x₂)+ξ(t)

\dot{x}₃=y₃−ax₃³+bx₃²−z₃+I_{ext,3}+D(x₂+x₁−2x₃)+ξ(t)

Where, D is the strength of coupling and ξ is the noise.

FIG. 4 shows the schematic diagram of coupling circuit (D in the expression) when bidirectional coupling of neuron N1. In case of unidirectional coupling, there is no I21 branch in neuron N1 coupling circuit. The neuronal synchronization mechanism can be understood as the results of mutual interaction and coordination between neurons. When the coupling strength increases, the interactions increase and it is easy to achieve synchronization; when the stimulating current Iₑₓₜ increases, it is similar to the action of noise, and it can achieve synchronization when exceeding a threshold value.

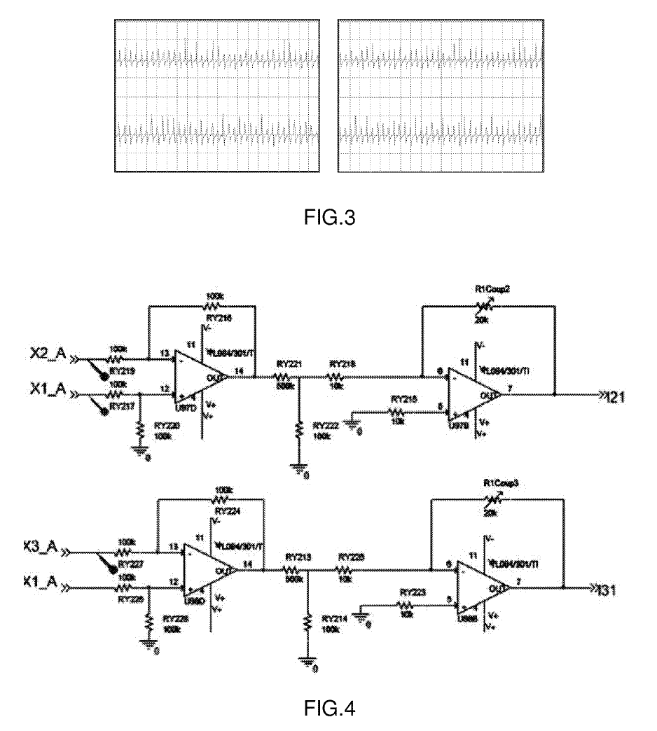

In the experiment, under the stimulating current Iₑₓₜ(D00-01)=96 uA, Iₑₓₜ(D10-11)=97 uA, Iₑₓₜ(D20-21)=78 uA, it is exactly synchronized when bidirectional coupling strength is equal to 0.5; as shown in FIG. 3, the curves at the top of the left and right figures represent the neuron N1 action response; the curve at the lower of left figure represents the neuron N2 action response and the curve at the lower of right figure represents the neuron N3 action response. The experiment showed that, when the bidirectional coupling strength decreases, neurons will not be synchronized any longer; but the increased bidirectional coupling strength will have no influence on the synchronization of synchronized neurons. It was found that bidirectional coupling neuronal synchronization requires a lower coupling strength than the unidirectional coupling, that is, neurons of bidirectional coupling are more easily synchronized.

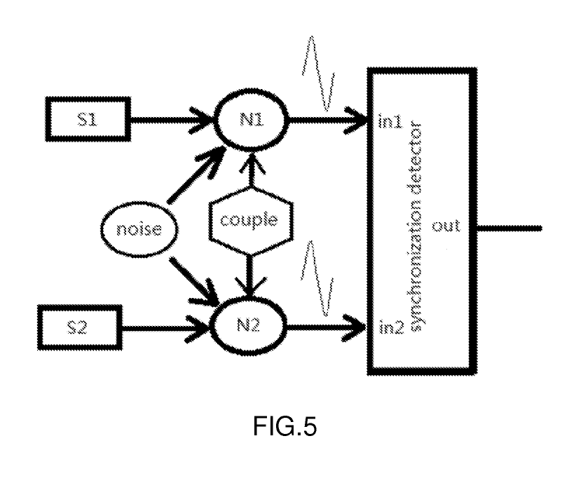

Referring to FIG. 5, two simplest neuron coupling networks are adopted, of which, N1 and N2 represent neuron circuit or neuron-like circuit, couple represents the coupling between neurons, S1 and S2 represent sensors, noise represent the noise generator, synchronization detector represents synchronization judgment unit. The operating principle of the system is as follows: external signals are converted to DC signals by sensors S1 and S2 (this technology is well-known, not the key points in the present invention), which act on neurons N1 and N2 respectively. The output signals of neurons S1 and S2 are oscillating signals. When the electrical signal of the sensor achieves sufficient strength under the action of coupling unit couple, the output oscillating signal of neurons S1 and S2 must be synchronized. Otherwise, the output oscillating signal of neurons S1 and S2 may be asynchronous. The signals of neurons S1 and S2 can be judged to achieve synchronization or not using the synchronization judgment unit-synchronization detector, and the result can be output. When the synchronization detector outputs the synchronization judgment results, it is considered that the system detects the external signals.

When adding the noise generating from noise generator or enhancing coupling strength of couple in the neurons, it can enhance the system sensitivity on detecting external signals. The noise effect can be understood as elevated energy input level, and the interaction between neurons may exert more energy, thus, it is easy to achieve synchronization; conversely, due to the noise effect, the electrical signal strength required for synchronization and the threshold value of coupling strength are reduced, and it is able to detect weaker electrical signals.

When acting on neural circuits N1 and N2 coupled by coupling circuit, adjust the coupling strength to the appropriate value, and when the intensity of electrical signal reaches a certain threshold, the output of neural circuits will be synchronized. In this case, it can be considered that the system has detected the external signals.

This method adopts sensors to convert the physical or biological signals to DC signals, acting on neuron or neuron-like circuits, to get the output voltage or current response of this kind of circuit. When the electrical signals converted by sensors are weak voltage or current, the output response of neuron or neuron-like circuits is resting. When the electrical signals converted by sensors exceed a certain threshold, the output responses represent as spiking discharge, bursting discharge or chaotic discharge.

The conventional signal detection method has two types; one type needs to design high-precision sense amplifier, and the output of detection circuit is the amplitude of the voltage or current signals; and the other type is to induce stochastic resonance with the noise and judge whether there is signal output by detecting SNR. In the present invention, by designing the coupled neuronal network and adjusting the coupling strength of coupling neurons, it can achieve synchronization rather than stochastic resonance when the DC signals reach a certain threshold, and the increased noise is to provide energy and lower the conditions for synchronization.

The foregoing invention has been described in detail by way of illustration and example for purposes of clarity and understanding. As is readily apparent to one skilled in the art, the foregoing are only some of the methods and compositions that illustrate the embodiments of the foregoing invention. It will be apparent to those of ordinary skill in the art that variations, changes, modifications and alterations may be applied to the compositions and/or methods described herein without departing from the true spirit, concept and scope of the invention.

What is claimed is:

1. A neuron network signal detection device comprises at least two coupled neurons, each neuron is connected to a sensor that transmits DC signal and the output terminal of coupled neuron is connected to a synchronization judgment unit.

2. The neuron network signal detection device according to claim 1, wherein the said neuron also connects a noise generator.

3. The neuron network signal detection device according to claim 1, wherein the said neuron is bidirectionally coupled.
